(19) United States
(12) Patent Application Publication
(10) Pub. No.: US 2004/0263561 A1
(43) Pub. Date: Dec. 30, 2004

(54) System and method of printing within circular area

(76) Inventors: Kurt Thiessen, San Diego, CA (US); Marius Buibas, Chula Vista, CA (US); Josep-Maria Serra, San Diego, CA (US)

Correspondence Address: HEWLETT-PACKARD COMPANY, Intellectual Property Administration, P.O. Box 272400, Fort Collins, CO, 80527-2400, US

(21) Appl. No.: 10/607,892

(22) Filed: Jun. 27, 2003

(51) Int. Cl. B41J 2/01

(52) U.S. Cl. 347/37

(57) ABSTRACT

A method of printing within a circular area of a media includes positioning a printhead including at least one column of nozzles above the circular area of the media, including orienting the at least one column of nozzles substantially perpendicular to a radius of the circular area extended below the printhead, rotating the media relative to the printhead, and printing at least one arcuate print pattern within the circular area of the media with the printhead while rotating the media.

### BACKGROUND

An inkjet printing system may include a printhead and an ink supply which supplies liquid ink to the printhead. The printhead ejects ink drops through a plurality of orifices or nozzles and toward a print media, such as a sheet of paper, so as to print onto the print media. Typically, the nozzles are arranged in one or more arrays such that properly sequenced ejection of ink from the nozzles causes characters or other images to be printed upon the print media as the printhead and the print media are moved relative to each other.

Optical data storage disks include a layer which may be read or written on by a laser of an optical drive system. Formats of optical data storage disks include, for example, compact disk (CD) media, CD-recordable (CD-R) media, CD-read only memory (CD-ROM) media, CD-rewritable (CD-RW) media, digital versatile disk or digital video disk (DVD) media, DVD-random access memory (DVD-RAM) media, and other types of rewritable optical media, such as magneto-optical (MO) disks and phase-change optical disks.

An optical data storage disk may include graphics or images printed on a side of the disk or on a sticker or label adhered to a side of the disk. Since the optical data storage disk is circular in shape, such graphics or images are printed within a circular area. Existing methods of printing typically cannot be performed concurrently with or performed at the same speed as other operations which rely on spinning of the optical data storage disk such as writing or “burning” data to the optical data storage disk.

Accordingly, it is desirable for a system which facilitates printing within a circular area, including printing for an optical data storage disk.

### SUMMARY

One aspect of the present invention provides a method of printing within a circular area of a media. The method includes positioning a printhead including at least one column of nozzles above the circular area of the media, including orienting the at least one column of nozzles substantially perpendicular to a radius of the circular area extended below the printhead, rotating the media relative to the printhead, and printing at least one arcuate print pattern within the circular area of the media with the printhead while rotating the media.

### BRIEF DESCRIPTION OF THE DRAWINGS

FIG. 1 is a block diagram illustrating one embodiment of an inkjet printing system according to the present invention.

FIG. 2 is a perspective view of one embodiment of an optical data storage disk constituting one embodiment of a print media according to the present invention.

FIG. 3 is a plan view of one embodiment of a label for an optical data storage disk constituting another embodiment of a print media according to the present invention.

FIG. 4 is a plan view illustrating one embodiment of printing within a circular area according to the present invention.

FIG. 5A is a schematic illustration of one embodiment of an arcuate print pattern printed within a circular area according to the present invention.

FIG. 5B is a schematic illustration of another embodiment of an arcuate print pattern printed within a circular area according to the present invention.

FIG. 6 is a schematic illustration of one embodiment of printing on and recording to an optical data storage disk according to the present invention.

### DESCRIPTION OF THE ILLUSTRATE EMBODIMENTS

In the following detailed description, reference is made to the accompanying drawings which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

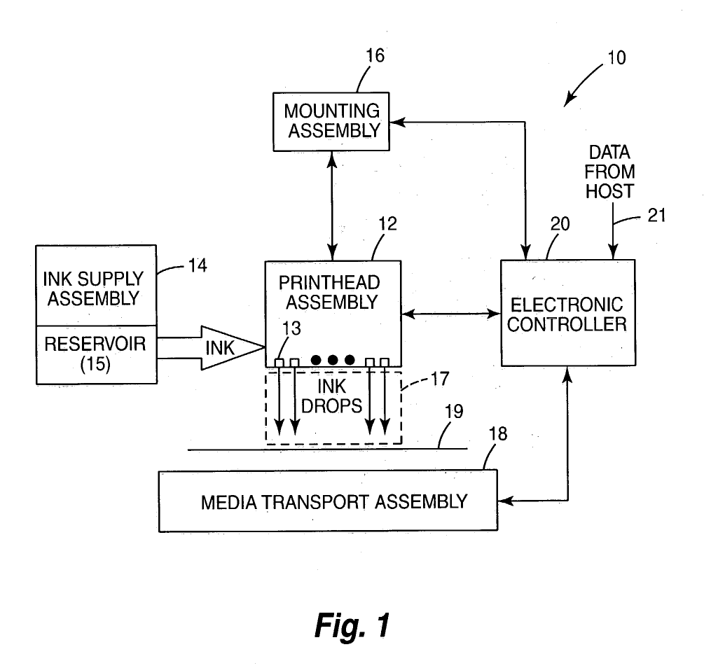

FIG. 1 illustrates one embodiment of a portion of an inkjet printing system 10. Inkjet printing system 10 includes a printhead assembly 12, an ink supply assembly 14, a mounting assembly 16, a media transport assembly 18, and an electronic controller 20. Printhead assembly 12 includes one or more printheads which eject drops of ink, including one or more colored inks, through a plurality of orifices or nozzles 13.

In one embodiment, the drops of ink are directed toward a medium, such as a print media 19, so as to print onto print media 19. Print media 19 includes any type of suitable sheet material, such as paper, card stock, envelopes, labels, transparencies, Mylar, and the like or other planar material such as an optical data storage disk, as described below. Typically, nozzles 13 are arranged in one or more columns or arrays such that properly sequenced ejection of ink from nozzles 13 causes characters, symbols, and/or other graphics or images to be printed upon print media 19 as printhead assembly 12 and print media 19 are moved relative to each other.

Ink supply assembly 14 supplies ink to printhead assembly 12 and includes a reservoir 15 for storing ink. As such, in one embodiment, ink flows from reservoir 15 to printhead assembly 12. In one embodiment, printhead assembly 12 and ink supply assembly 14 are housed together in an inkjet print cartridge or pen. In another embodiment, ink supply assembly 14 is separate from printhead assembly 12 and supplies ink to printhead assembly 12 through an interface connection, such as a supply tube.

Mounting assembly 16 positions printhead assembly 12 relative to media transport assembly 18, and media transport assembly 18 positions print media 19 relative to printhead assembly 12. As such, a print region 17 within which printhead assembly 12 deposits ink drops is defined adjacent to nozzles 13 in an area between printhead assembly 12 and print media 19. In one embodiment, as described below, print media 19 is rotated during printing by media transport assembly 18.

Mounting assembly 16 typically includes a carriage and a carriage drive assembly. As such, printhead assembly 12 is removably mounted in, and supported by, the carriage, and the carriage drive assembly moves the carriage and, therefore, printhead assembly 12 relative to print media 19. A conventional carriage drive assembly may include a carriage guide which supports the carriage, a drive motor, and a belt and pulley system which moves the carriage along the carriage guide.

Electronic controller 20 communicates with printhead assembly 12, mounting assembly 16, and media transport assembly 18. Electronic controller 20 receives data 21 from a host system, such as a computer, and includes memory for temporarily storing data 21. Typically, data 21 is sent to inkjet printing system 10 along an electronic, infrared, optical or other information transfer path. Data 21 represents, for example, an image or graphics to be printed. As such, data 21 forms a print job for inkjet printing system 10 and includes one or more print job commands and/or command parameters.

In one embodiment, electronic controller 20 provides control of printhead assembly 12 including timing control for ejection of ink drops from nozzles 13. As such, electronic controller 20 defines a pattern of ejected ink drops which form characters, symbols, and/or other graphics or images on print media 19. Timing control and, therefore, the pattern of ejected ink drops, is determined by the print job commands and/or command parameters. In one embodiment, logic and drive circuitry forming a portion of electronic controller 20 is located on printhead assembly 12. In another embodiment, logic and drive circuitry is located off printhead assembly 12.

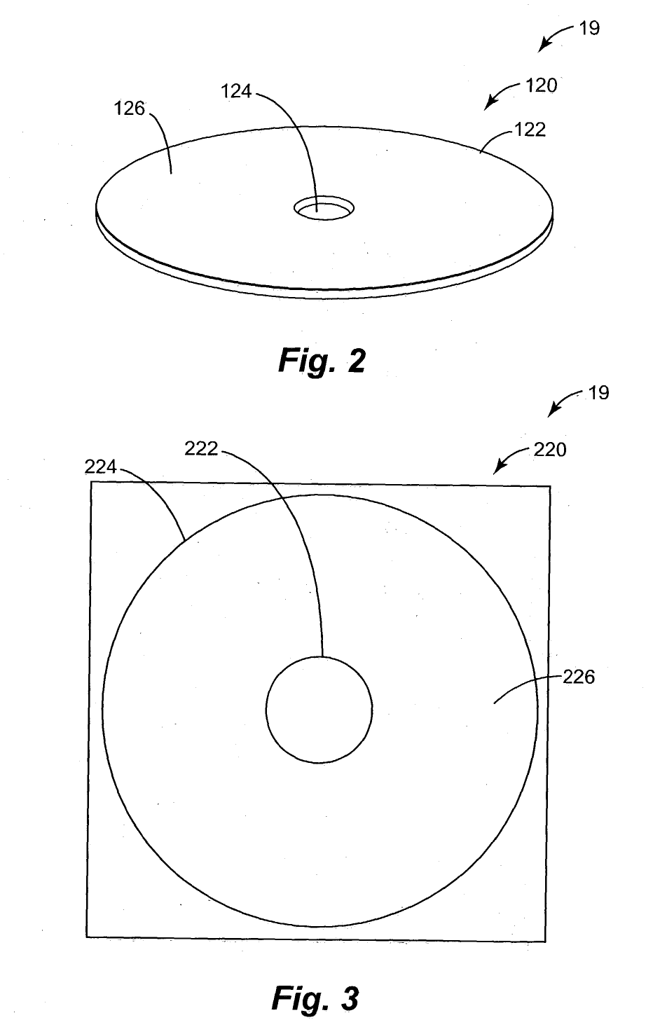

In one embodiment, as illustrated in FIG. 2, print media 19 includes an optical data storage disk 120. Optical data storage disk 120 may include, for example, a compact disk (CD) media, a CD-recordable (CD-R) media, a CD-read only memory (CD-ROM) media, a CD-rewritable (CD-RW) media, a digital versatile disk or digital video disk (DVD) media, a DVD-random access memory (DVD-RAM) media, or any other type of writable optical media, such as a magneto-optical (MO) disk or phase-change optical disk.

Optical data storage disk 120 includes a circular member 122 having a central bore or opening 124 formed therein. In one embodiment, opening 124 is sized to accommodate a drive pin or other engagement feature of an optical disk drive (not shown). As described below, optical data storage disk 120 includes a layer which may be read or written on by a recording head.

As illustrated in the embodiment of FIG. 2, one side of optical data storage disk 120 includes a circular area 126 which provides a printable area for optical data storage disk 120. As such, printhead assembly 12 prints graphics or images directly on optical data storage disk 120, as described below. In one embodiment, circular area 126 has an area for opening 124 of optical data storage disk 120. Thus, in one embodiment, circular area 126 is an annular area.

In one embodiment, as illustrated in FIG. 3, print media 19 includes a label 220 for optical data storage disk 120. In one embodiment, label 220 includes a circular area 226. In one embodiment, circular area 226 is sized to fit optical data storage disk 120 and has an area for opening 124 of optical data storage disk 120. Thus, in one embodiment, circular area 226 is an annular area.

In one embodiment, label 220 includes a backing material and a printable material removably adhered to the backing material. In one embodiment, label 220 is square with the inner and outer diameters of circular area 226 defined by concentric circular slits 222 and 224 in the printable material. Slits 222 and 224 extend through the printable material to the backing material, but do not pass through the backing material, to permit the portion of the printable material including circular area 226 to be peeled off of the backing material.

In one embodiment, the printable material includes an adhesive layer such that the printable material and the backing material may be separated and the printable material may be adhered to optical data storage disk 120. As such, printhead assembly 12 prints graphics or images on label 220, as described below, and label 220 is adhered to a side of optical data storage disk 120.

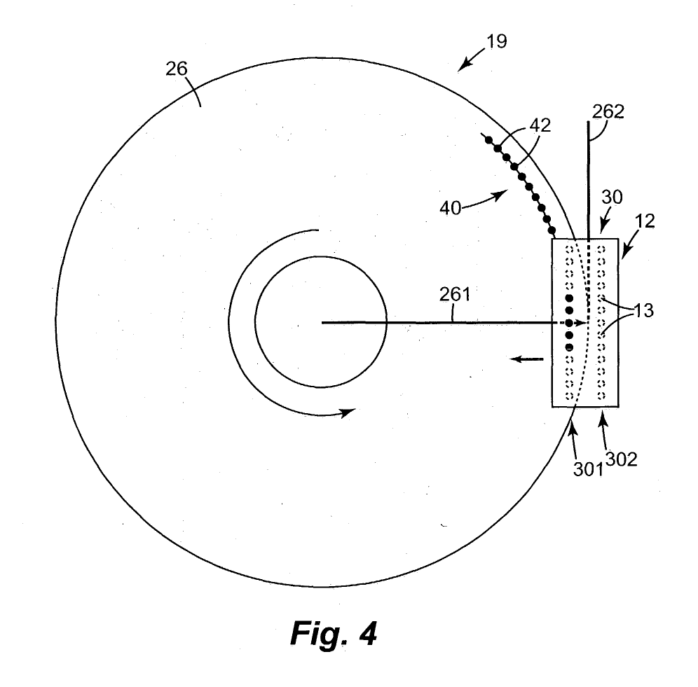

As illustrated in the embodiment of FIG. 4, nozzles 13 of printhead assembly 12 are arranged in one or more columns 30. In one exemplary embodiment, nozzles 13 of printhead assembly 12:are arranged in two columns, including a first column 301 and a second column 302. In one embodiment, first column 301 and second column 302 are spaced from and oriented substantially parallel to each other.

Printhead assembly 12 is positioned relative to print media 19 (including optical data storage disk 120 as print media 19 or label 220 as print media 19) such that at least one column, for example, column 301 of nozzles 13 is positioned in spaced relation from and above a circular area 26 of print media 19. For example, when optical data storage disk 120 constitutes print media 19, circular area 126 of optical data storage disk 120 constitutes circular area 26, and when label 220 constitutes print media 19, circular area 226 of label 220 constitutes circular area 26. As such, print region 17 extends between nozzles 13 and circular area 26.

In one embodiment, printhead assembly 12 is positioned relative to print media 19 such that column 30 of nozzles 13 is oriented substantially perpendicular to a radius 261 of circular area 26 of print media 19. Radius 261 is extended to a position of and/or below printhead assembly 12 such that column 30 of nozzles 13 is oriented substantially perpendicular to radius 261 extended below printhead assembly 12. As such, printhead assembly 12 is oriented substantially parallel to a tangent 262 of circular area 26 at radius 261 of circular area 26.

In one embodiment, print media 19 is rotated relative to printhead assembly 12 during printing. Print media 19 (including optical data storage disk 120 as print media 19 and label 220 as print media 19) is rotated, for example, by media transport assembly 18 (FIG. 1). To rotate print media 19, media transport assembly 18 may include, for example, a rotational member such as a spindle or platter which engages or supports print media 19 and a rotational motor-which rotates the rotational member such that rotational motion of the motor is imparted to print media 19 by the rotational member.

While print media 19 is rotated, printhead assembly 12 creates an arcuate print pattern 40 within circular area 26. More specifically, dots 42 are created on print media 19 by ejecting ink through nozzles 13 of printhead assembly 12. Dots 42 are printed along and follow an arc centered about a center of circular area 26 so as to create arcuate print pattern 40. With column 30 of nozzles 13 oriented substantially perpendicular to radius 261 of circular area 26, arcuate print pattern 40 is created substantially perpendicular to radius 261 of circular area 26 as print media 19 is rotated.

In one embodiment, multiple nozzles 13 within one column of printhead assembly 12, for example, nozzles within column 301 simultaneously print dots on print media 19 as print media 19 rotates relative to printhead assembly 12. As such, a speed at which print media 19 is rotated during printing can be increased. Thus, a speed at which arcuate print pattern 40 is created can be increased.

As illustrated in the embodiment of FIG. 4, printhead assembly 12 and print media 19 are moved relative to each other in a direction substantially parallel to radius 261 of circular area 26. In one embodiment, printhead assembly 12 is moved relative to print media 19 along radius 261 of circular area 26. Printhead assembly 12 is moved relative to print media 19, for example, by mounting assembly 16. In another embodiment, print media 19 is moved relative to printhead assembly 12 such that printhead assembly 12 follows radius 261 of circular area 26. Print media 19 is moved relative to printhead assembly 12, for example, by media transport assembly 18.

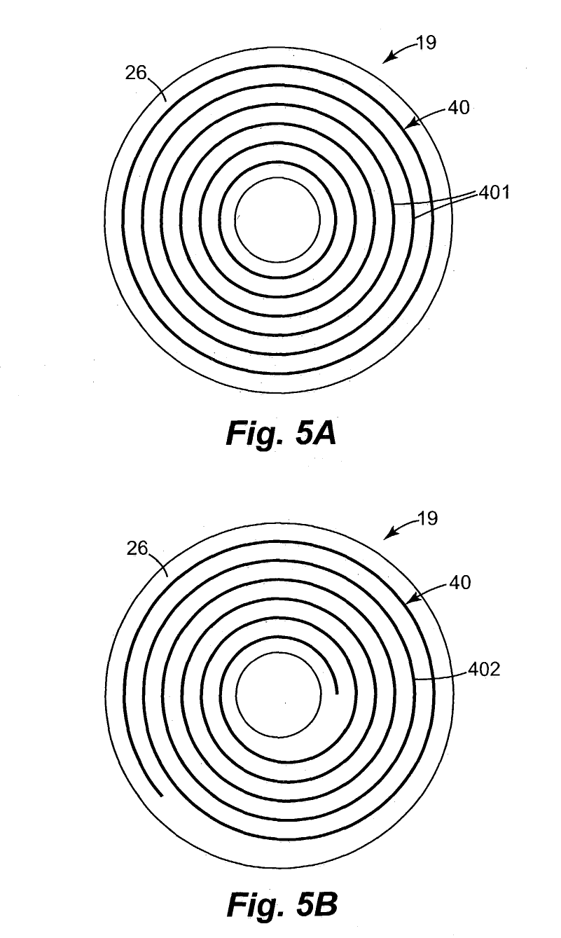

In one embodiment, printhead assembly 12 and print media 19 are moved relative to each other so as to position printhead assembly 12 between an outer diameter and an inner diameter of circular area 26. Thus, by moving printhead assembly 12 and print media 19 relative to each other, arcuate print pattern 40 is created within a printable area and, more specifically, within circular area 26 of print media 19. In one embodiment, as illustrated in FIG. 5A, printhead assembly 12 and print media 19 are moved relative to each other such that arcuate print pattern 40 includes concentric print patterns 401 formed within circular area 26. In another embodiment, as illustrated in FIG. 5B, printhead assembly 12 and print media 19 are moved relative to each other such that arcuate print pattern 40 includes a spiral print pattern 402 formed within circular area 26.

It is understood that FIGS. 4, 5A, and 5B are simplified schematic illustrations of one embodiment of arcuate print pattern 40 (including concentric print patterns 401 and spiral print pattern 402). In addition, while only one column of nozzles 13 is illustrated as printing arcuate print pattern 40 in FIG. 4, it is understood that multiple columns of nozzles 13 may print respective arcuate print patterns within circular area 26 of print media 19.

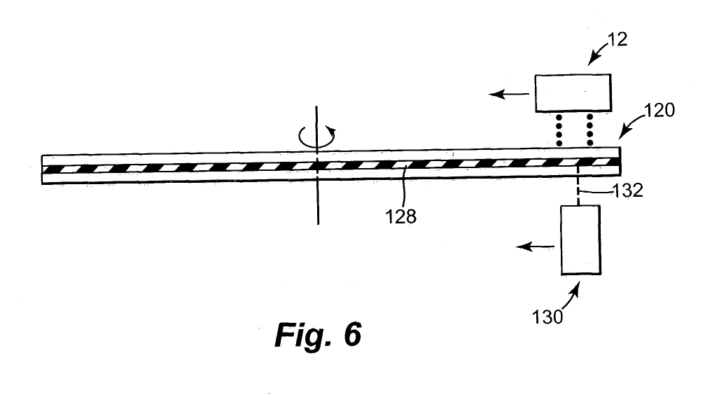

In one embodiment, as illustrated in FIG. 6, optical data storage disk 120 includes a recording layer 128. As such, a recording head 130 is positioned on a side of optical data storage disk 120 for recording digital data to recording layer 128. Recording head 130 records digital data to recording layer 128 by directing a recording beam 132, such as a laser beam, to recording layer 128 while optical data storage disk 120 rotates. As such, recording beam 132 creates marks or pits representing digital data in recording layer 128.

It is understood that FIG. 6 is a simplified schematic illustration of one embodiment of optical data storage disk 120, including recording layer 128. For example, in addition to recording layer 128, optical data storage disk 120 may also include other layers, such as protective, reflective, and/or dielectric layers, formed on one or more sides of a substrate material.

As illustrated in the embodiment of FIG. 6, printhead assembly 12 is positioned on a first side of optical data storage disk 120 and recording head 130 is positioned on a second side of optical data storage disk 120 opposite the first side. As such, printhead assembly 12 prints on optical data storage disk 120 from the first side and recording head 130 records to optical data storage disk 120 from the second side as optical data storage disk 120 rotates relative to printhead assembly 12 and recording head 130. In one embodiment, printhead assembly 12 and recording head 130 simultaneously print on and record to optical data storage disk 120. More specifically, printhead assembly 12 prints on optical data storage disk 120 from the first side and recording head 130 records to optical data storage disk 120 from the second side as optical data storage disk 120 rotates at one predetermined speed.

As illustrated in the embodiment of FIG. 6, printhead assembly 12 and recording head 130 move relative to optical data storage disk 120 while printing on and recording to optical data storage disk 120. Printhead assembly 12 and recording head 130, for example, move between the outer diameter and the inner diameter of optical data storage disk 120 during printing and recording. In one embodiment, printhead assembly 12 and recording head 130 each move relative to optical data storage disk 120 in a direction substantially parallel to a radius of optical data storage disk 120.

In one exemplary embodiment, as illustrated in FIG. 6, printhead assembly 12 and recording head 130 print on and record to, respectively, optical data storage disk 120 while moving from the outer diameter toward the inner diameter of optical data storage disk 120. It is understood, however, that printhead assembly 12 and/or recording head 130 may print on and record to, respectively, optical data storage disk 120 while moving from the inner diameter toward the outer diameter of optical data storage disk 120.

As described above, by positioning printhead assembly 12 with nozzles 13 oriented substantially perpendicular to radius 261 of circular area 26, multiple nozzles can be operated in unison. As such, print speed can be increased. Thus, optical data storage disk 120 can be rotated at an increased speed when printing within circular area 126 of optical data storage disk 120. Accordingly, in one embodiment, optical data storage disk 120 is rotated at one speed during printing and recording. In addition, printhead assembly 12 and recording head 130 are moved relative to optical data storage disk 120 at the same speed. As such, printing and recording can be completed during the same time.

Although specific embodiments have been illustrated and described herein, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electromechanical, electrical, and computer arts will readily appreciate that the present invention may be implemented in a very wide variety of embodiments. This application is intended to cover any adaptations or variations of the specific embodiments discussed herein. Therefore, it is manifestly intended that this invention be limited only by the claims and the equivalents thereof.

What is claimed is:

1. A method of printing within a circular area of a media, the method comprising:
positioning a printhead including at least one column of nozzles above the circular area of the media, including orienting the at least one column of nozzles substantially perpendicular to a radius of the circular area extended below the printhead;
rotating the media relative to the printhead; and
printing at least one arcuate print pattern within the circular area of the media with the printhead while rotating the media.

2. The method of claim 1, wherein positioning the printhead includes orienting the at least one column of nozzles substantially parallel to a tangent of the circular area at the radius of the circular area.

3. The method of claim 1, wherein printing the at least one arcuate print pattern includes printing the at least one arcuate print pattern along an arc centered about a center of the circular area of the media.

4. The method of claim 1, wherein printing the at least one arcuate print pattern includes printing the at least one arcuate print pattern substantially perpendicular to the radius of the circular area of the media with the printhead while rotating the media.

5. The method of claim 1, wherein printing the at least one arcuate print pattern includes printing concentric print patterns within the circular area of the media.

6. The method of claim 1, wherein printing the at least one arcuate print pattern includes printing a spiral print pattern within the circular area of the media.

7. The method of claim 1, wherein the at least one column of nozzles includes a first column of nozzles and a second column of nozzles spaced from and oriented substantially parallel to the first column of nozzles, and wherein printing the at least one arcuate print pattern includes printing a first arcuate print pattern with the first column of nozzles and a second arcuate print pattern with the second column of nozzles.

8. The method of claim 1, further comprising:
moving the printhead and the media relative to each other in a direction substantially parallel to the radius of the circular area of the media.

9. The method of claim 8, wherein moving the printhead and the media relative to each other includes moving the printhead along the radius of the circular area of the media.

10. The method of claim 1, wherein the circular area of the media includes an annular area of the media.

11. The method of claim 1, wherein the media includes an optical data storage disk.

12. The method of claim 1, wherein the media includes a label for an optical data storage disk.

13. A system for printing within a circular area of a media, the system comprising:
a printhead including at least one column of nozzles, the at least one column of nozzles adapted to be oriented substantially perpendicular to a radius of the circular area extended below the printhead; and
an assembly adapted to rotate the media relative to the printhead,
wherein the printhead is adapted to print at least one arcuate print pattern within the circular area of the media as the assembly rotates the media relative to the printhead.

14. The system of claim 13, wherein the at least one column of nozzles are adapted to be oriented substantially parallel to a tangent of the circular area at the radius of the circular area.

15. The system of claim 13, wherein the at least one arcuate print pattern follows an arc centered about a center of the circular area of the media.

16. The system of claim 13, wherein the printhead is adapted to print the at least one arcuate print pattern substantially perpendicular to the radius of the circular area of the media as the assembly rotates the media relative to the printhead.

17. The system of claim 13, wherein the at least one arcuate print pattern includes concentric print patterns.

18. The system of claim 13, wherein the at least one arcuate print pattern includes a spiral print pattern.

19. The system of claim 13, wherein the at least one column of nozzles includes a first column of nozzles and a second column of nozzles spaced from and oriented substantially parallel to the first column of nozzles, and wherein the printhead is adapted to print a first arcuate print pattern with the first column of nozzles and a second arcuate print pattern with the second column of nozzles.

20. The system of claim 13, wherein the printhead is adapted to move relative to the media in a direction substantially parallel to the radius of the circular area of the media.

21. The system of claim 13, wherein the printhead is adapted to move relative to the media along the radius of the circular area of the media.

22. The system of claim 13, wherein the circular area of the media includes an annular area of the media.

23. The system of claim 13, wherein the media includes an optical data storage disk.

24. The system of claim 13, wherein the media includes a label for an optical data storage disk.

25. A method of printing on and recording to an optical data storage disk, the method comprising:
positioning a printhead adjacent a first side of the optical data storage disk, including orienting a column of nozzles of the printhead substantially perpendicular to a radius of the optical data storage disk extended below the printhead;
positioning a recording head adjacent a second side of the optical data storage disk opposite the first side thereof;
rotating the optical data storage disk relative to the printhead and the recording head;
printing at least one arcuate print pattern on the optical data storage disk with the printhead while rotating the optical data storage disk; and
recording to the optical data storage disk with the recording head while rotating the optical data storage disk.

26. The method of claim 25, wherein positioning the printhead includes orienting the column of nozzles substantially parallel to a tangent of the optical data storage disk at the radius of the optical data storage disk.

27. The method of claim 25, wherein printing the at least one arcuate print pattern includes printing the at least one arcuate print pattern along an arc centered about a center of the optical data storage disk.

28. The method of claim 25, wherein printing the at least one arcuate print pattern includes printing the at least one arcuate print pattern substantially perpendicular to the radius of the optical data storage disk with the printhead while rotating the optical data storage disk.

29. The method of claim 25, wherein printing the at least one arcuate print pattern includes printing concentric print patterns on the optical data storage disk.

30. The method of claim 25, wherein printing the at least one arcuate print pattern includes printing a spiral print pattern on the optical data storage disk.

31. The method of claim 25, wherein printing on the optical data storage disk and recording to the optical data storage disk includes simultaneously printing on the optical data storage disk and recording to the optical data storage disk.

32. The method of claim 25, wherein printing on the optical data storage disk and recording to the optical data storage disk includes printing on the optical data storage disk and recording to the optical data storage disk while rotating the optical data storage disk at a predetermined speed.

33. The method of claim 25, further comprising:
moving the printhead and the optical data storage disk relative to each other and the recording head and the optical data storage disk relative to each other in a direction substantially parallel to the radius of the optical data storage disk.

34. The method of claim 33, wherein moving the printhead and the optical data storage disk relative to each other includes moving the printhead along the radius of the optical data storage disk relative to the optical data storage disk.

35. The method of claim 33, wherein moving the printhead and the optical data storage disk relative to each other and the recording head and the optical data storage disk relative to each other includes moving the printhead relative to the optical data storage disk at a predetermined speed and moving the recording head relative to the optical data storage disk at the predetermined speed.

36. A system for printing on and recording to an optical data storage disk, the system comprising:
a printhead adapted to be positioned adjacent a first side of the optical data storage disk and including at least one column of nozzles, the at least one column of nozzles adapted to be oriented substantially perpendicular to a radius of the optical data storage disk extended below the printhead;
a recording head adapted to be positioned adjacent a second side of the optical data storage disk opposite the first side thereof; and
an assembly adapted to rotate the optical data storage disk relative to the printhead and the recording head,
wherein the printhead is adapted to print at least one arcuate print pattern on the optical data storage disk as the assembly rotates the optical data storage disk relative to the printhead, and
wherein the recording head is adapted to record to the optical data storage disk as the assembly rotates the optical data storage disk relative to the recording head.

37. The system of claim 36, wherein the at least one column of nozzles are adapted to be oriented substantially parallel to a tangent of the optical data storage disk at the radius of the optical data storage disk.

38. The system of claim 36, wherein the at least one arcuate print pattern follows an arc centered about a center of the optical data storage disk.

39. The system of claim 36, wherein the printhead is adapted to print the at least one arcuate print pattern substantially perpendicular to the radius of the optical data storage disk as the assembly rotates the optical data storage disk relative to the printhead.

40. The system of claim 36, wherein the at least one arcuate print pattern includes concentric print patterns.

41. The system of claim 36, wherein the at least one arcuate print pattern includes a spiral print pattern.

42. The system of claim 36, wherein the printhead and the recording head are adapted to simultaneously print on and record to the optical data storage disk.

43. The system of claim 36, wherein the printhead is adapted to print on the optical data storage disk and the recording head is adapted to record to the optical data storage disk as the assembly rotates the optical data storage disk at a predetermined speed.

44. The system of claim 36, wherein the printhead and the recording head are each adapted to move relative to the optical data storage disk in a direction substantially parallel to the radius of the optical data storage disk.

45. The system of claim 36, wherein the printhead is adapted to move relative to the optical data storage disk along the radius of the optical data storage disk.

46. The system of claim 36, wherein the printhead and the recording head are each adapted to move relative to the optical data storage disk at a predetermined speed.

47. A system for processing an optical data storage disk, the system comprising:
means for rotating the optical data storage disk; and
means for simultaneously printing on the optical data storage disk from a first side of the optical data storage disk and recording to the optical data storage disk from a second side of the optical data storage disk opposite the first side as the optical data storage disk rotates.

48. The system of claim 47, wherein means for simultaneously printing on and recording to the optical data storage disk includes a printhead positioned on the first side of the optical data storage disk, the printhead including at least one column of nozzles oriented substantially perpendicular to a radius of the optical data storage disk extended below the printhead.

49. The system of claim 48, wherein means for simultaneously printing on and recording to the optical data storage disk further includes a recording head positioned on the second side of the optical data storage disk.
